(19) United States
(12) Patent Application Publication
(10) Pub. No.: US 2011/0168682 A1
(43) Pub. Date: Jul. 14, 2011

(54) LASER LAP WELDING METHOD FOR GALVANIZED STEEL SHEET

(76) Inventors: Tsukasa HAGIHARA, Hamamatsu-shi (JP); Takayoshi DAN, Hamamatsu-shi (JP)

(21) Appl. No.: 12/984,918

(22) Filed: Jan. 5, 2011

(30) Foreign Application Priority Data
Jan. 8, 2010 (JP) 2010-002855

(51) Int. Cl. B23K 26/20

(52) U.S. Cl. 219/121.64

(57) ABSTRACT

A laser lap welding method, for a galvanized sheet, includes, irradiating a laser beam while traveling at a laser traveling speed (v) mm/sec which leads a power per volume in unit time (P/øtv) of the laser beam within a range from 0.07 to 0.11 kWsec/mm³ when the laser beam has a power (P) which is not less than 7 kW and an irradiation spot diameter (ø) which is not less than 0.4 mm and a galvanized steel sheet has a thickness (t) mm, so that an elongated hole is formed in a molten pool extending backward from a laser irradiation spot at least in the steel sheet on the outer surface side, whereby metal vapor produced by laser irradiation is vented through the elongated hole backward in a laser traveling direction and in a direction towards a laser irradiation source.

### CROSS-RELATED APPLICATIONS

This application claims priority from Japanese Patent Application No, 2010-002855; filed Jan. 8, 2010, the disclosure of which is incorporated herein by reference in its entirety.

### FIELD OF THE INVENTION

The present invention relates to a laser lap welding method for a galvanized steel sheet.

### BACKGROUND OF THE INVENTION

In a wide variety of industries such as the automobile industry, galvanized steel sheets are commonly used because they are high in specific strength and low in cost as well as they are excellent in corrosion resistance. In particular, in the automobile industry, etc., there have been attempts to introduce laser beam welding which has excellent characteristics such as the capability of high-accuracy, high-quality, and high-speed processing compared to spot welding and the like when a number of galvanized steel sheets are overlaid and welded together.

When galvanized steel sheets are overlaid and welded with a laser (hereinafter, such welding is simply referred to as “laser lap welding”), for example, the galvanized steel sheets are overlaid one on top of the other in a manner such that the facing galvanized layers of two neighboring galvanized steel sheets are in contact with each other, and irradiated with a laser beam from a carbonic acid gas laser, a YAG laser, etc., so that the overlaid galvanized steel sheets are melted and bonded together

To perform favorable bonding, iron layers of the upper and lower galvanized steel sheets need to interpenetrate. The melting point and boiling point of zinc are approximately 420° C. and 907° C., respectively, and they are much lower than the melting point of iron, which is approximately 1535° C. Accordingly, only when galvanized steel sheets are overlaid such that the galvanized layers face in contact with each other and are subjected to laser irradiation, evaporated zinc from each galvanized layer blows off molten metal therearound or remains in the molten metal as bubbles. This gives rise to the problem of kinds of weld defects such as pits, porosities, and worm.

As a countermeasure thereto, JP 60-210386 A, JP 61-74793 A, and JP2007-38269A disclose a laser lap welding method for a galvanized steel sheet, in which a gap for venting zinc vapor is provided between galvanized steel sheets to be subjected to lap welding, using a spacer or a difference in level, and laser lap welding is performed in this state. Furthermore, JP 61-135495 A, JP 07-155974 A, JP 10-193149 A, JP 2000-326080 A, and JP 2004-261849 A, disclose a laser lap welding method for a galvanized steel sheet, in which a convexo-concave or a bend is formed in one of two adjacent galvanized steel sheets so that a gap, as mentioned above, is formed with the galvanized steel sheets being overlaid.

In addition, JP 2005-144504 A discloses a laser lap welding method for a galvanized steel sheet, in which one of the adjacent galvanized steel sheets to be subjected to laser lap welding is bent in advance by irradiating a laser beam at a portion near each laser lap welding point of the galvanized steel sheet.

### BRIEF SUMMARY OF THE INVENTION

However, introducing a gap of approximately 0.1 mm between galvanized steel sheets which are overlaid one on top of the other requires much time and effort, and process management therefor is made difficult. In the example as disclosed in JP 2005-144561A, laser irradiation on each portion to be welded needs to be performed twice. In the automobile industry in which a further increasing demand for laser lap welding of galvanized steel sheets is expected, the number of galvanized steel sheets to be processed is large. In addition, the sheet thickness thereof is approximately 1 mm, so that more time and effort are required, and process management is more difficult.

The present invention has been made in view of the aforementioned circumstances, and an object of the invention is to provide a laser lap welding method for a galvanized steel sheet, in which no additional process for avoiding welding defects due to zinc vapor is necessary, and high speed and high quality weldbonding is allowed with the galvanized steel sheets being in intimate contact with one another.

In order to achieve the above object, a laser lap welding method for a galvanized steel sheet according to the present invention, includes: the steps of: preparing two steel sheets, at least one of which is the galvanized steel sheet, in lapped configuration that the steel sheets are overlaid one on top the other with a galvanized layer thereof being located at an interface of the steel sheets; and irradiating an outer surface of any one of the two steel sheets in an overlaid region with a laser beam, wherein said irradiating includes irradiating the laser beam while traveling at a laser traveling speed (v) mm/sec which leads a power per volume in unit time (P/øtv) of the laser beam within a range from 0.07 to 0.11 kWsec/mm³ when the laser beam has a power P which is not less than 7 kW and an irradiation spot diameter ø which is not less than 0.4 mm and the galvanized steel sheet has a thickness (t) mm, so that an elongated hole is formed in a molten pool extending backward from a laser irradiation spot at least in the steel sheet on the outer surface side, whereby metal vapor produced by laser irradiation is vented through the elongated hole backward in a laser traveling direction and in a direction towards a laser irradiation source.

In the above-described method, zinc vapor produced by the evaporation of zinc on the face-to-face contacting surfaces is vented through an elongated hole produced in a molten pool without adversely affecting the molten pool, which results in excellent laser lap welding without defects.

With laser welding, bonding is provided by solidification of molten metal which is fused by being heated and melted by laser irradiation energy. Thus, merely increasing a movement speed of laser irradiation results in shortage of power to be supplied per unit time, which causes poor welding. On the other hand, if a power density is too high, a melted portion cannot be fused and will burn out. However, when laser irradiation is performed with high speed and high power density, and when the power per volume in unit time, i.e., power density, is within the aforementioned range, a keyhole (recess in the molten pool produced by the evaporation of metal) extending backward from a laser irradiation position is formed. Furthermore, the evaporation of metal concentrates on the front end of the elongated keyhole in the traveling direction of laser irradiation. Metal vapor is vented backward from the front end along the traveling direction of laser irradiation toward a laser irradiation source side (obliquely upward toward the back in the case in which galvanized steel sheets are overlaid one on top of the other), so that the keyhole is made elongated. Furthermore, zinc vapor is vented mainly from or near the front end of the elongated hole thus formed, so that the zinc vapor does not blow away molten metal in the molten pool and the molten metal does not remain in the molten pool.

In the above-described method, if the laser power P is less than 7 kW, a travelling speed of laser irradiation must be decreased or the irradiation spot diameter must be made smaller than that mentioned above, in order to obtain a necessary power density. If the travelling speed is low, only a short key hole is formed. If the irradiation spot diameter is too small, the width of the molten pool is made narrow. Thus, no elongated hole is formed. As used herein, the word “elongate” in the term “elongated hole” means that a length of the elongated hole in the laser travelling direction is significantly longer than the width of the hole in the direction perpendicular thereto. The length of the elongated hole is at least two times, preferably at least three to five times, the width thereof. A too long keyhole reduces welding quality.

The matter that a power per volume in unit time (P/øtv) of the laser beam is within the foregoing predetermined range represents that the power P of the laser to be irradiated is determined according to an irradiation width (irradiation spot diameter) ø, a sheet thickness t, and a laser travelling speed v (a movement distance per unit time of the irradiation spot). This was approximately and empirically determined from an applicable sheet thickness of a galvanized steel sheet to be subjected to laser lap welding. Accordingly, not in the sense that a volume of a steel sheet material to be melted per unit time is equal to “øtv”, assuming that the fused region thereof has an uniform shape in the laser travelling direction and a cross-section shape thereof is an inverted triangle in which the height thereof (interpenetrated depth) is 2t (a thickness of two sheets), it is thought that the “øtv” is determined by multiplying the cross-sectional area (ø×2t/2) of the triangle by the travelling speed (v). If two galvanized steel sheets to be lap-welded are different in sheet thickness (t), the sheet thickness (t) of the galvanized metal sheet disposed on the laser irradiation source side is used as a reference. When three or more galvanized steel sheets are lap welded, half of a total sheet thickness is applied.

According to the invention, the travelling speed (v) is preferably in the range from 167 to 200 mm/sec (i.e., 10 to 12 m/min). Even when the laser travelling speed (v) is set multiplying a unit time by power per volume, it is advantageous to make the power P as small as possible, and to set the laser travelling speed (v) in a predetermine power range to be not high as far as possible, because a burden on facilities is reduced and a good welding quality is obtained.

The present invention is applicable only when a galvanized layer is formed on one or both of two mating faces of the aforementioned two steel sheets, but is not applicable when no galvanized layer is formed on each mating surface. Since no zinc vapor is produced if no galvanized layer is present on each mating face, it is useless to perform the method of the invention. It was confirmed by experiment that in such a case, an elongated hole is less likely to be formed in a molten pool. Thus, it is thought that a pressure of issuing zinc vapor somewhat participates in formation of the elongated hole.

The galvanized steel plate to which the present invention is applied is a thin sheet with a thickness of 0.5 to 2 mm which is mainly used for automobiles, and which includes a galvanized layer with a thickness of 4 to 12 μm. Since the amount of zinc itself in the galvanized layer is smaller than that of the steel sheet, and the melting point of steel is much higher than the boiling point of zinc, welding conditions would not be significantly changed in accordance with the thickness of the galvanized layer. The steel is mild steel, alloy steel, high-tensile steel, or the like. The galvanization is not limited to plating with pure zinc, and may be plating with alloy containing zinc as a chief material as long as effects of the present invention are exerted.

As described above, according to the laser lap welding method for a galvanized steel sheet of the invention, welding defects caused by zinc vapor can be avoided without extra process, high speed and high quality weldbonding can be performed without much time and effort, and process management is made easier. Furthermore, laser lap welding having excellent technical characteristics becomes possible for lap welding galvanized steel sheets.

### BRIEF DESCRIPTION OF THE DRAWINGS

FIG. 1 is a perspective view showing performance of laser lap welding for a galvanized steel sheet as one example of the present invention.

FIG. 2 is a perspective view conceptually showing the behaviors of molten liquid and vapor of weld metal at the time of the welding shown in FIG. 1.

FIG. 3 is a cross-sectional view which conceptually shows a weld portion at the time of the welding shown in FIG. 1 and which is taken along the traveling direction.

FIG. 4 is a view conceptually showing the weld portion as viewed from above at the time of the welding shown in FIG. 1.

FIGS. 5(a) to 5(e) are graphical representations showing experimental results when galvanized steel sheets having a thickness of 0.7 mm are subjected to laser lap welding while changing a laser power and a laser travelling speed for each irradiation spot diameter ø.

FIGS. 6(a) to 6(b) are graphical representations showing experimental results when galvanized steel sheets having a thickness of 1.2 mm are subjected to laser lap welding while changing a laser power and a laser travelling speed for each irradiation spot diameter ø.

FIGS. 7(a) to 7(c) are graphical representations showing experimental results when galvanized steel sheets having a thickness of 0.6 mm are subjected to laser lap welding while changing a laser power and a laser travelling speed for each irradiation spot diameter ø.

### DETAILED DESCRIPTION OF THE INVENTION

The present invention now will be described more fully hereinafter in which embodiments of the invention are provided with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs.

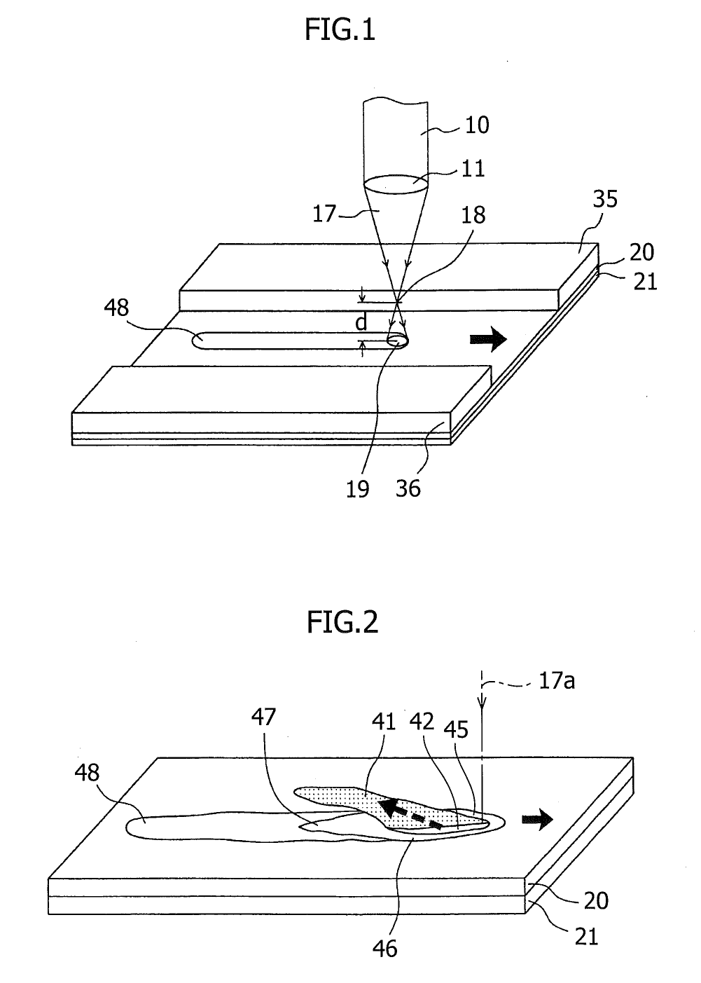

In FIG. 1, reference numeral 10 denotes a fiber of a laser oscillator, reference numeral 11 denotes a lens, reference numerals 20 and 21 denote galvanized steel sheets overlaid one on top of the other (top is 20, and bottom is 21), and reference numerals 35 and 36 denote holding jigs for the galvanized steel sheets. Furthermore, reference numeral 17 denotes a laser beam, reference numeral 18 denotes the focal point of the laser beam, arrows in rays of light represent a laser irradiation direction, reference numeral 19 denotes a laser irradiation spot formed on the galvanized steel sheet 20, and reference numeral 48 denotes a weld bead. Moreover, a bold arrow indicates the traveling direction (direction in which welding is performed) of laser irradiation. Furthermore, “d” denotes the defocus amount of laser irradiation.

The two galvanized steel sheets 20 and 21 are overlaid one on top of the other, and fixed with the holding jigs 35 and 36 at respective two opposite sides of each welding point, so that the upper and lower galvanized steel sheets 20 and 21 are brought into intimate contact with each other with the galvanized layer being used as a contact surface. In this state, the laser beam 17 emitted from a fiber 10 of a laser oscillator is caused to travel in the welding direction (to the right as viewed in the drawing) at a predetermined travelling speed while being applied along a direction perpendicular to the surface of the weld face (galvanized steel sheet 20). At the time of welding, a lens 11 is adjusted so that the laser beam 17 is focused before the weld face (as viewed in the drawing, directly above the weld face) and a predetermined irradiation spot diameter is obtained. It should be noted that the laser irradiation direction is not limited to the perpendicular direction as mentioned above. The laser irradiation direction may be oriented forward or backward along the travelling direction so that the laser impinges at some angle of incidence on the weld face. However, it is preferable that the laser irradiation direction be generally perpendicular to the direction which intersects the travelling direction. In the illustrated example, the weld surface is depicted near the lens 11 for convenience. However, the present invention may be implemented as laser remote welding with a long focal length.

As shown in the experimental results below, the welding method of the invention is characterized in that a significantly higher power (7 kW or more) than that of conventional laser lap welding is selected, and that the laser with such high power is irradiated with the laser being travelled at a significant high speed (9 m/min or more) compared with convention travelling speed, so that an elongated hole is produced and zinc vapor is vented while suppressing the energy to be used for the weld region per unit time at a level which does not cause transition to a disconnected state.

FIGS. 2 to 4 conceptually show a molten pool and behaviors of vapor of weld metal during welding. In these drawings, reference numeral 17a denotes a laser beam axis, reference numeral 40 denotes a molten portion leading edge, reference numeral 41 denotes a laser-induced plume, reference numeral 42 denotes an elongated hole (elongated keyhole) produced by venting metal vapor, reference numerals 45 and 46 respectively denote molten pools produced on two opposite sides of the elongated hole 42, and reference numeral 47 denotes a molten pool behind the elongated hole. Moreover, in these drawings again, bold arrows indicate the traveling direction of laser irradiation, and an arrow accompanied by a bold broken line indicates the flow of metal vapor.

The upper and lower galvanized steel sheets 20 and 21 are melted by laser irradiation. Since irradiation energy density is large, the molten portion leading edge 40 melts steeply and deeply on the back side in the traveling direction. A part of the metal rapidly evaporates from the surface. Furthermore, metal vapor (laser-induced plume) produced by rapid evaporation is vented backward and upward (toward the laser irradiation side) from a portion slightly behind the irradiation portion (from the side opposite to the traveling direction, i.e., from the left side of the irradiation portion as viewed in the drawing) while pushing liquid metal therearound and thereabove.

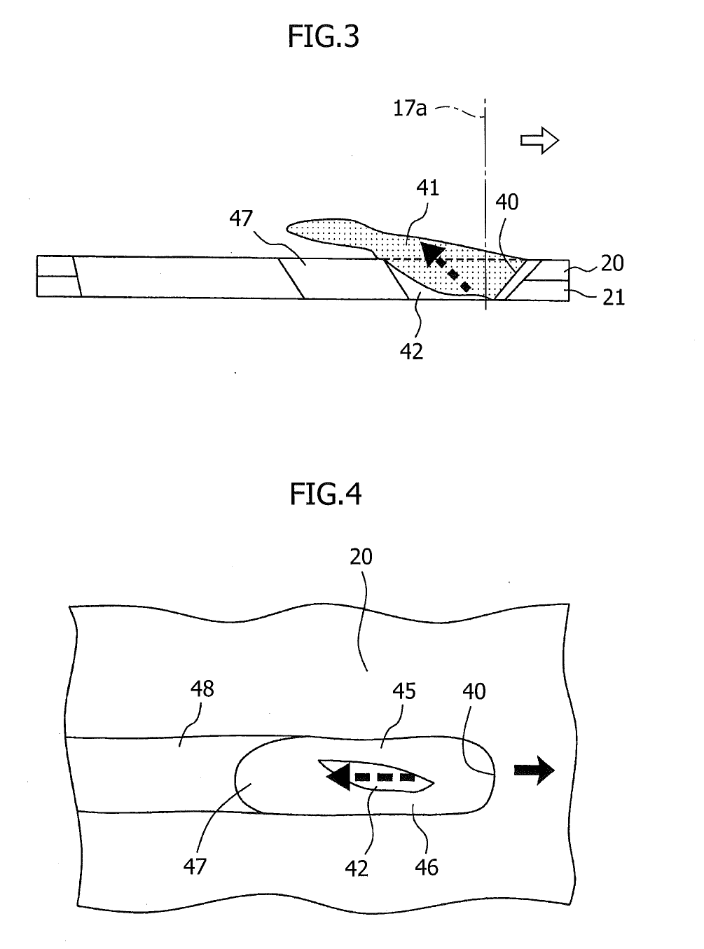

The reason why the laser-induced plume 41 blows out in the above-described direction is not only that a portion near the center line of the irradiation portion in the traveling direction is subject to the longest laser irradiation time and the highest laser beam power density, but also that an unmelted solid metal layer exists on the side in the traveling direction of irradiation, the side in the irradiation direction (lower side as viewed in FIGS. 2 and 3), and both sides of the irradiation portion in the traveling direction (above and below the irradiation portion as viewed in FIG. 4). Accordingly, the laser-induced plume 41 is produced along the center line of the irradiation portion in the traveling direction. Consequently, the laser-induced plume 41 is produced behind the laser irradiation spot and along the center line of irradiation in the traveling direction. As a result, a hole 42 in which no molten metal exists and which is long in the traveling direction is produced at that position. Moreover, elongated molten pools 45 and 46 are produced on both sides of this elongated hole 42 in the traveling direction. Furthermore, the molten metal therein flows in the direction opposite to the traveling direction due to metal vapor pressure to merge into a molten pool 47 behind the elongated hole 42 in the traveling direction. In this example, it was observed that an elongated hole (elongated keyhole) with a width of approximately 1 mm and a length of approximately 3 mm was formed when satisfactory welding was performed.

In the present invention, not only is an elongated hole simply formed, but also zinc vapor jets as the laser-induced plume 41 or as a part thereof obliquely upward toward the back from the leading edge and surrounding portion of the formed elongated hole. Accordingly, molten metal around and above the zinc vapor is not blown away or is blown away only slightly. Furthermore, the zinc vapor does not remain in a molten pool

Zinc has a melting point (419.5° C.) and a boiling point (907° C.) which are much lower than the melting point (1535° C.) of iron as described previously, and also has a low melting heat and a low vaporization heat (7.322 kJ/mol and 115.3 kJ/mol, respectively) (those of iron, which is the chief material of a steel sheet, are 13.8 kJ/mol and 349.6 kJ/mol, respectively. It should be noted, however, that actually these four values are slightly changed by the influences of zinc and the influences of additives and compounds in a steel sheet). Accordingly, if the amount of heat transferred from the steel sheet located on the laser irradiation side is large, zinc instantly melts and evaporates, and a large amount of produced zinc vapor blows away molten metal existing above the zinc vapor. If the specific heat and the vaporization heat of zinc are large, vaporization of zinc is delayed, so that a large amount of produced zinc vapor blows away molten metal existing thereabove.

However, iron has a lower thermal conductivity than copper and the like, and liquid as molten iron has a further lower thermal conductivity than solid iron. Moreover, as described previously, zinc has a low heat of vaporization, and on the other hand, energy density of laser irradiation is large and the travelling speed thereof is high. As a result, steel gradually melts and evaporates from the irradiated-side surface of a galvanized steel sheet, and then zinc in the irradiation portion on the contact surfaces of the galvanized steel sheets 20 and 21 rapidly melts and evaporates due to the energy of laser irradiation to be vented from the leading edge and surrounding portion of the aforementioned elongated hole. Accordingly, favorable lap welding is performed

### Example 1

After that, to verify the relationship between the laser power, the laser spot diameter, galvanized steel sheets with a thickness t=0.7 mm were used with the galvanized steel sheets being overlaid one on top of the other with no gap so that each galvanized layers was being an interface therebetween, to carry out experiments to evaluate a keyhole forming situation, presence of zinc gas defects, and weld quality. The experiment was conducted on each of the following spot diameters while changing stepwise a laser power P (kW) and a laser travelling speed v (m/min): (a) spot diameter ø=0.52 mm; (b) spot diameter ø=0.64 mm; (c) spot diameter ø=0.83 mm; (d) spot diameter ø=0.94 mm; and (e) spot diameter ø=1.06 mm.

In the experiments, a DISK laser oscillator (a maximum output 10 kW and a transmission fiber diameter ø=0.3 mm, and a maximum output 16 kW and a transmission fiber diameter ø=0.2 mm) manufactured by TRUMPF CO, was used with a laser beam of a wavelength within the range from 1000 to 1200 nm which is suitable for a fiber transmission laser.

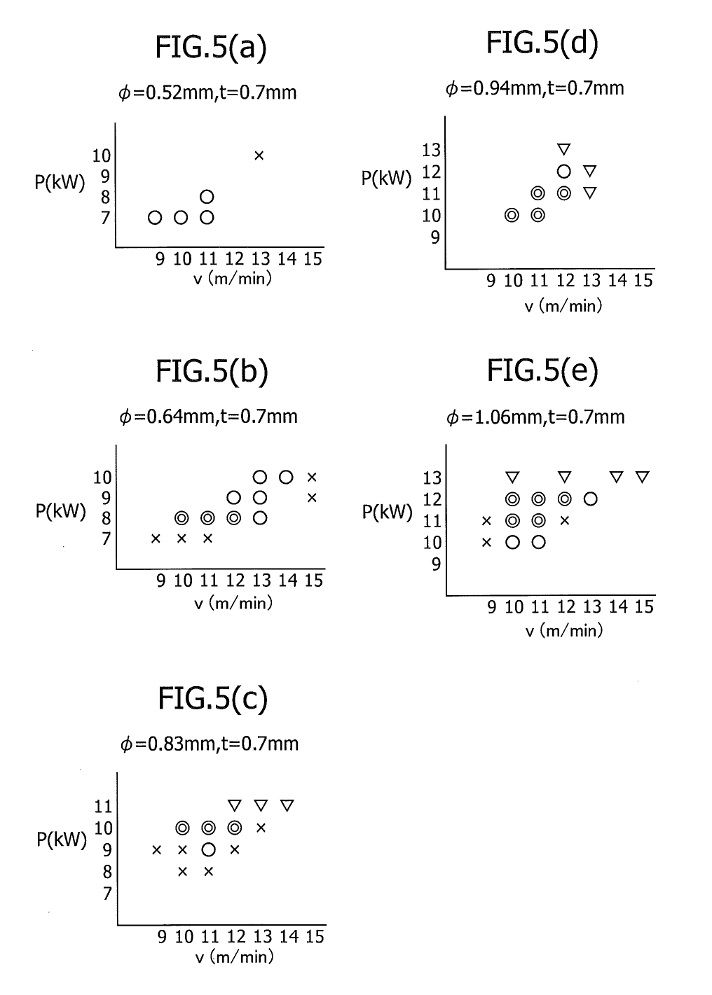

FIGS. 5(a) to 5(e) show the experimental results. In each of these drawings, the symbol “double circle” indicates that when the setting value corresponding thereto was used, an elongated keyhole extending backward from a laser irradiation position was formed, no zinc gas defects were produced, and a good welding quality was obtained; the symbol “circle” indicates that when the setting value corresponding thereto was used, a similar elongated keyhole was formed; the zinc gas defects were produced at a substantially problem-free level, a slight dent was produced in the rear side, and the obtained welding quality was slightly inferior to that of “double circle”; the symbol “inverted triangle” indicates that when the setting value corresponding thereto was used, an excessively long keyhole was formed, a large dent was produced in the rear side, the obtained welding quality was problematic; and the symbol “cross” indicates that when the setting value corresponding thereto was used, merely an ordinary very short hole was formed, zinc gas defects were always produced.

In each case, the setting values which lead to satisfactory welding results are distributed in a region extending from the lower left to the upper right of the graph wherein the laser travelling speed v increases with the increase of laser power P, and when the laser power P is not more than 8 kW, good welding results were not obtained even when the laser travelling speed was reduced. Although not shown, similar experiments were performed on the spot diameters ø=0.42 mm and ø=0.31 mm, which are smaller than the spot diameter above using some setting values. In these experiments, preferable results were not obtained. In addition, in a region where the power P is high, it was all that a keyhole extends longer even when the laser traveling speed v was increased, and no preferable results were obtained. Thus, it is considered that there is an upper limit to power P, this upper limit differs depending on the spot diameter ø, and is determined from the P/øtv value (described later) which varies according to the spot diameter ø.

It would be understood that the elongated keyhole which contributes to emission of zinc vapor is not only “elongated” from a geometrically fineness ratio point of view, but also has an upper and lower values in length and width which allow emission of zinc vapor. When the spot diameter ø is small and the width of a keyhole is physically very small, an opening space from which zinc vapor can be vented is insufficient. On the other hand, when the spot diameter ø is overlarge, even if a power P and a travelling speed v are selected so that a power density to be commensurate with the spot diameter, a produced keyhole is excessively long. As a result, zinc gas can be vented, but a large dent is formed in a rear side. In any event, regarding a time constant that is associated with the fluidity of molten metal, there are upper and lower limits of a power density which are commensurate with a spot diameter ø. Thus, it is necessary to select a suitable power P and a suitable travelling speed v so that the power density falls within the range between the upper and lower limits.

When a power per volume in unit time (P/øtv) of the laser beam (kWsec/mm³) is determined for each setting value used in the experiments above, the setting values, from which a preferable welding result was obtained, lead an approximately constant value within a range between 0.07 and 0.11 kWsec/mm³ regardless of the spot diameter. For example, when the spot diameter ø is 0.64 mm, the power P is 8 kW, the laser travelling speed v is 10 m/min (167 mm/sec), P/øtv is 11 kWsec/mm³. In addition, when the spot diameter is 1.06 mm, power P is 12 kW, and laser travelling speed v is 12 m/min (200 mm/sec), P/øtv is 0.08 kWsec/mm³. Accordingly, using such a relationship enables to estimate preferable values of a laser power P and a laser travelling speed v, which are suitable for a certain spot diameter ø and a certain thickness (t).

Furthermore, the same experiment was conducted for the following cases under the same conditions of the above-described experiments: a case in which a lower steel sheet is a non-galvanized steel sheet (hereinafter referred to as non-plated steel sheet); a case in which an upper steel sheet is a non-plated steel sheet; and a case in which each of an upper and lower steel sheets is a non-plated steel sheet. It was found that when only the lower sheet was a non-plated steel sheet, approximately the same results were obtained as those obtained when each of the upper and lower sheets was a plated steel sheet, whereas when only the upper sheet was a non-plated sheet, a preferable setting value range was narrow. In addition, when each of the upper and lower sheets was a non-plated steel sheet, of course, no zinc vapor was generated and no elongated key hole was formed. In view of the above, it is presumed that a blowout pressure of zinc vapor also influences formations of an elongated keyhole.

### Example 2

After that, under the same conditions as those of the experiments above, galvanized steel sheets with a thickness t=1.2 mm were used with the galvanized steel sheets being overlaid one on top of the other with no gap so that each galvanized layers was being an interface therebetween, to carry out experiments to evaluate a keyhole forming situation, presence of zinc gas defects, and weld quality. The experiment was conducted on each of the following spot diameters while changing stepwise a laser power P (kW) and a laser travelling speed v (m/min): (a) spot diameter ø=0.42 mm; and (b) spot diameter ø=0.52 mm.

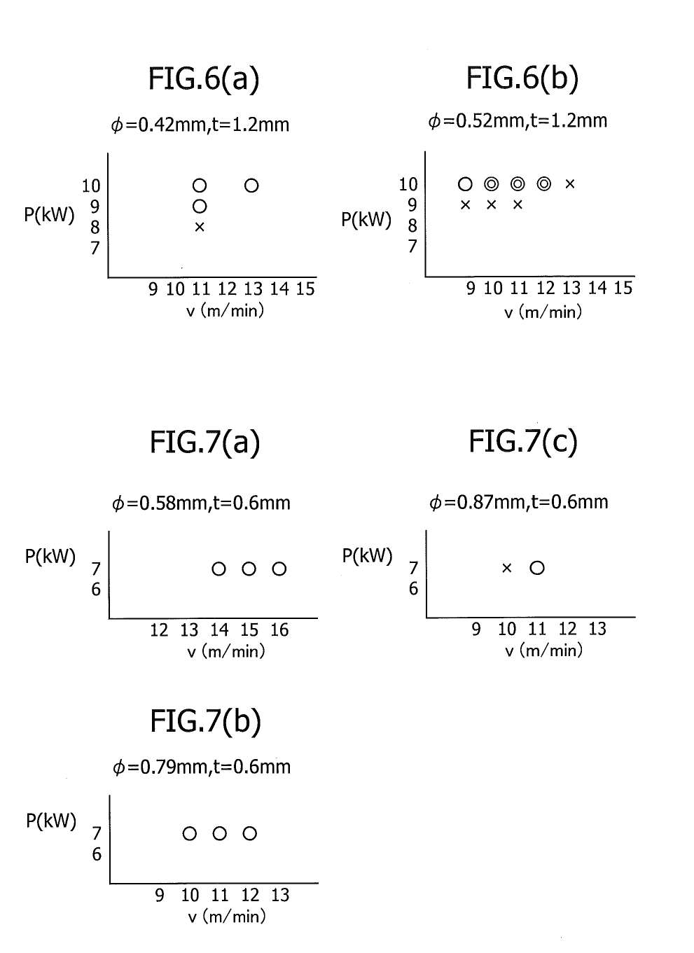

FIGS. 6(a) to 6(b) show the experimental results. The symbols in each drawing above have the same meaning used in the experiments described above. Although the number of the samples is smaller than that when the thickness is 0.7 mm, an approximately similar trend was demonstrated. The experiment was also sporadically conducted on the spot diameters ø=0.64 mm, which was larger than that illustrated, and on the spot diameter ø=0.31 mm, which was smaller than that illustrated. Preferable results were obtained for the spot diameter ø=0.64 mm, whereas no preferable results were for the spot diameter ø=0.31 mm. These trends are also similar to those when the thickness is 0.7 mm as described above.

Furthermore, the values of power per volume in unit time (P/øtv) of a laser beam when the setting values which lead to good welding results were selected were, for example, P/øtv was 0.10 (kWsec/mm³) when an irradiation spot diameter ø was 0.52 mm, a power P was 10 kW, and a travelling speed is 10 mm/min (167 mm/sec); and P/øtv was 0.08 (kWsec/mm³) when an irradiation spot diameter ø and a power P were the same as above, and a travelling speed is 12 mm/min (200 mm/sec). These values are also similar to those when the thickness is 0.7 mm as described above.

### Example 3

After that, in consideration of the experimental results above, galvanized steel sheets with a thickness t=0.6 mm were used with the galvanized steel sheets being overlaid one on top of the other with no gap so that each galvanized layer was an interface therebetween, to carry out an additional experiment to evaluate a keyhole forming situation, presence of zinc gas defects, and weld quality. The experiment was conducted on each of the following spot diameters at a laser power P of 7 kW while changing a laser travelling speed v (m/min): (a) spot diameter ø=0.58 mm; (b) spot diameter ø=0.79 mm, and spot diameter ø=0.87 mm. In this additional experiment, a fiber laser oscillator (maximum output is 7 kW, transmission fiber diameter ø is 0.2 mm, and wavelength is 1070 nm) manufactured by TRUMPF CO. was used.

FIGS. 7(a) to 7(c) show the experimental results. The symbols used therein have the same meaning used in the experiments described above. From the previous experimental results, a travelling speed v which is expected to lead to a preferable result with respect to a power P, a spot diameter ø, and a thickness t could be assumed. Thus, in the additional experiment, preferable results were obtained under almost all conditions employed for this experiment. When an irradiation spot diameter ø was 0.58 mm and a travelling speed v was 14 mm/min (233 mm/sec), and when an irradiation spot diameter ø was 0.79 mm and a travelling speed v was 10 mm/min (167 mm/sec), P/øtv was 0.09 (kWsec/mm³). When an irradiation spot diameter ø was 0.79 mm and a travelling speed v was 12 mm/min (200 mm/sec), and when an irradiation spot diameter ø was 0.87 mm and a travelling speed v was 11 mm/min (183 mm/sec), P/øtv was 0.7 (kWsec/mm³). These values are also generally similar to those when the thickness was 0.7 mm and 1.2 mm as described above.

In the examples above, although the sheet thicknesses used were only 0.7 mm and 1.2 mm for the experiments, and 0.6 mm for the additional experiment, galvanized steel sheets that are industrially used in large numbers are thin steel sheets with a thickness in the range from 0.5 to 2 mm. Thus, when a setting value is selected using the aforementioned approximate expression based on the experimental results, preferable welding conditions can be achieved.

As described above, even though the laser lap welding method for a galvanized steel plate of the invention requires no additional process for venting zinc vapor, a preferable laser lap welding with no zinc defects can be performed with high reproducibility. Along with high-speed travelling of a laser beam, the present method enables mass productivity in lap welding of galvanized steel sheets which are industrially used in large numbers.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed. The following claims are provided to ensure that the present application meets all statutory requirements as a priority application in all jurisdictions and shall not be construed as setting forth the full scope of the present invention.

What is claimed is:

1. A laser lap welding method for a galvanized steel sheet, comprising the steps of:
preparing two steel sheets, at least one of which is a galvanized steel sheet, in lapped configuration that the steel sheets are overlaid one on top the other with a galvanized layer thereof being located at an interface of the steel sheets; and
irradiating an outer surface of any one of the two steel sheets in an overlapped region with a laser beam,
wherein said irradiating includes irradiating the laser beam while traveling at a laser traveling speed (v) mm/sec which leads to a power per volume in unit time (P/øtv) of the laser beam within a range from 0.07 to 0.11 kWsec/mm³ when the laser beam has a power (P) which is not less than 7 kW and an irradiation spot diameter (ø) which is not less than 0.4 mm and the galvanized steel sheet has a thickness (t) mm, so that an elongated hole is formed in a molten pool extending backward from a laser irradiation spot at least in the steel sheet on the outer surface side, whereby metal vapor produced by laser irradiation is vented through the elongated hole backward in a laser traveling direction and in a direction towards a laser irradiation source.

2. The laser lap welding method for a galvanized steel sheet according to claim 1, wherein the travelling speed (v) is in the range from 167 to 299 mm/sec.
